(19) United States
(12) Patent Application Publication
(10) Pub. No.: US 2009/0284074 A1
(43) Pub. Date: Nov. 19, 2009

(54) Inverter

(76) Inventor: Ming-Hsiang Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,381

(22) Filed: May 19, 2008

(51) Int. Cl. H02J 9/00

(52) U.S. Cl. 307/64

(57) ABSTRACT

An inverter includes at least two power sources and an uninterruptible power supply device. The at least two power sources include a mains outlet and fuel, solar energy, wind power, battery (fuel cell) based power generation devices. The uninterruptible power supply device includes a power source selector and a constant-current controller built therein. The uninterruptible power supply device has output terminals connectable to electrical appliances and input terminals connected to the at least two power sources via the power source selector and the constant-current controller. As such, the power source selector and the constant-current controller function to effect distribution and regulation of the at least two power sources for supply of constant current used by the electrical appliances and timed scheduling of the various power sources.

### FIELD OF THE INVENTION

The present invention relates to an inverter, and in particular to a combination of at least two power sources and an uninterruptible power supply device for realizing distribution of input power for constant current supply and timed control of other power sources and being applicable to electrical appliance facilities, precision instruments, and the likes.

### BACKGROUND OF THE INVENTION

Unexpected power failures often make substantial loss for almost every business and may even cause uncountable property losses for some specific fields. Computer facilities are an example. Unless properly backed up, total loss of data storage may be resulted in the computer facilities when unexpected power failures happen. To avoid such an uncontrollable event, uninterruptible power supply systems are available in the market for supplying supplementary or alternative power supply when power failures occur in the regular supply of power. With such supplementary power supply, the computer facilities are provided with sufficient time to save and store and even back up the data storage and then shut down until the regular supply of power is recovered.

The conventional uninterruptible power supply system is effective to provide a supplementary power to temporarily maintain the operation of electrical appliances, the power that the uninterruptible power supply system can provide is limited, which is only sufficient for taking operation to save data, but is often insufficient to maintain continuous operation of the whole computer facilities. That means, the computers cannot resume normal operation until the regular supply of power is recovered. Further, the conventional uninterruptible power supply system is so operated to accumulate electrical power that is received from other power sources, such as a mains outlet. In a situation that the power supplied from the mains may be unstable or short of supply, obtaining the accumulated power only from a single source is apparently an unreliable way for the operation of the uninterruptible power supply system.

In view of the above problems, the present invention is aimed to provide an inverter that overcomes the problems.

### SUMMARY OF THE INVENTION

An objective of the present invention is to provide an inverter that features a combination of at least two power sources and an uninterruptible power supply device, wherein the uninterruptible power supply device comprises a power source selector and a constant-current controller built therein and the power source selector and the constant-current controller function to distribute and regulate power inputs from the at least two power sources so as to effect distribution over various power sources for supply of constant current and thus stabilize the input power for electrical appliance facilities.

Another objective of the present invention is to provide an inverter that features a combination of at least two power sources and an uninterruptible power supply device, wherein the uninterruptible power supply device comprises a power source selector and a constant-current controller built therein and the constant-current controller further comprises a timer for timed scheduling of various power sources to thereby stabilize the input power for electrical appliance facilities.

To realize the above objectives, in accordance with the present invention, an inverter comprises at least two power sources and an uninterruptible power supply device. The at least two power sources comprise a mains outlet and fuel, solar energy, wind power, battery (fuel cell) based power generation devices. The uninterruptible power supply device includes a power source selector and a constant-current controller built therein. The uninterruptible power supply device has output terminals connectable to electrical appliances and input terminals connected to the at least two power sources via the power source selector and the constant-current controller. As such, the power source selector and the constant-current controller function to effect distribution and regulation of the at least two power sources for supply of constant current used by the electrical appliances and timed scheduling of the various power sources.

### BRIEF DESCRIPTION OF THE DRAWINGS

The present invention will be apparent to those skilled in the art by reading the following description of a preferred embodiment thereof with reference to the drawings, in which:

FIG. 1 is a schematic block diagram of an inverter constructed in accordance with the present invention;

FIG. 2 is a schematic block diagram illustrating an application of the inverter of the present invention in accordance with a first embodiment;

FIG. 3 is a schematic block diagram illustrating an application of the inverter of the present invention in accordance with a second embodiment;

FIG. 4 is a schematic view illustrating the connection of the inverter with electrical appliances; and

FIG. 5 is a circuit block diagram of a power source selector in accordance with the present invention.

### DETAILED DESCRIPTION OF THE PREFERRED EMBODIMENTS

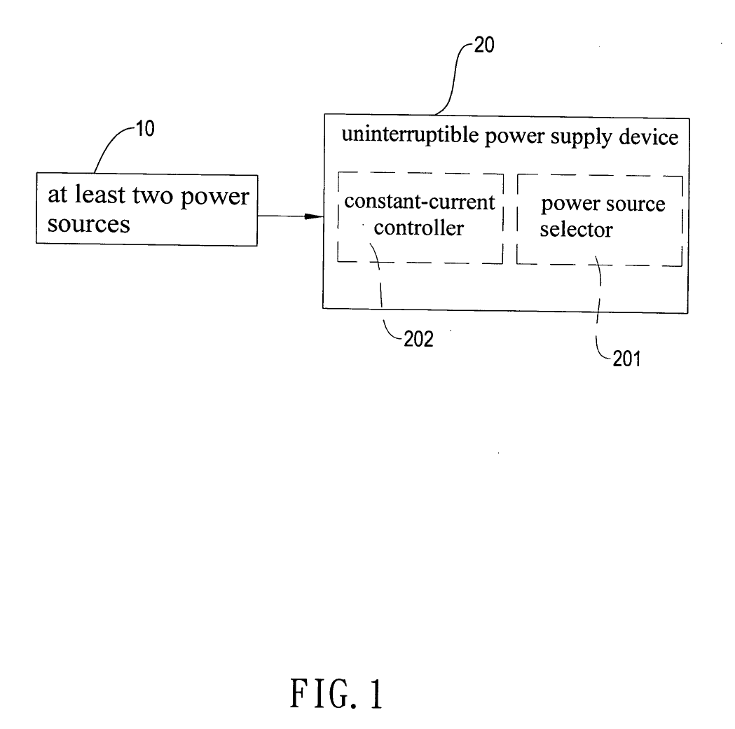

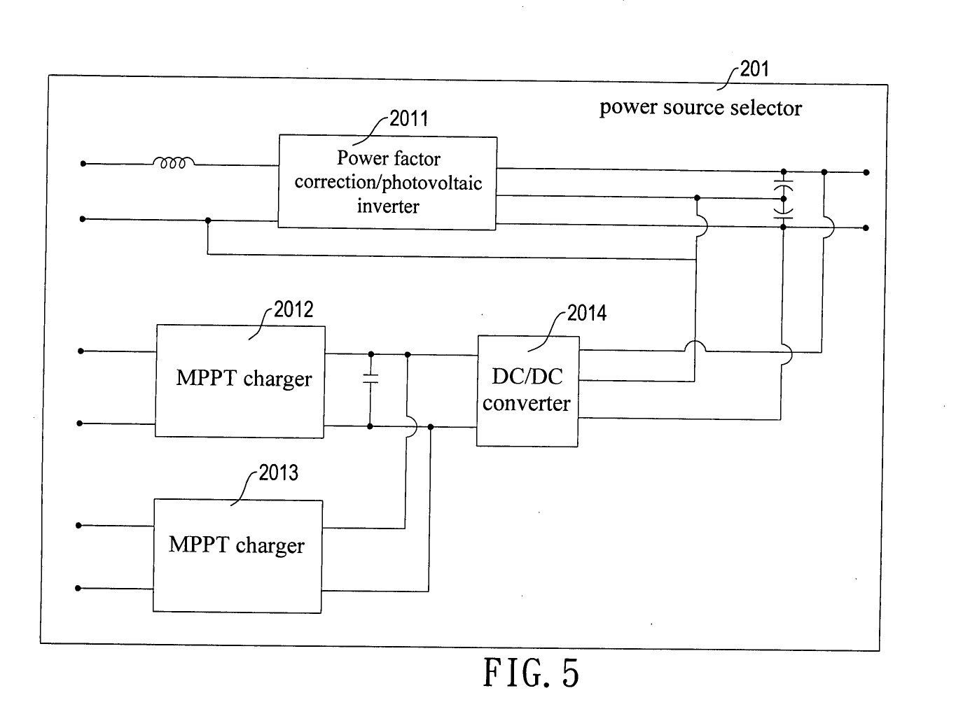

With reference to the drawings and in particular to FIGS. 1-5, the present invention provides an inverter, which comprises at least two power sources 10. The two power source 10 includes direct-current (DC) power sources and an alternate-current (AC) power sources, such as mains outlet 101, bicycle power generator 102, fuel power generator 103, battery power generator 104, fuel cell power generator 105, wind power generator 106, and solar power generator 107.

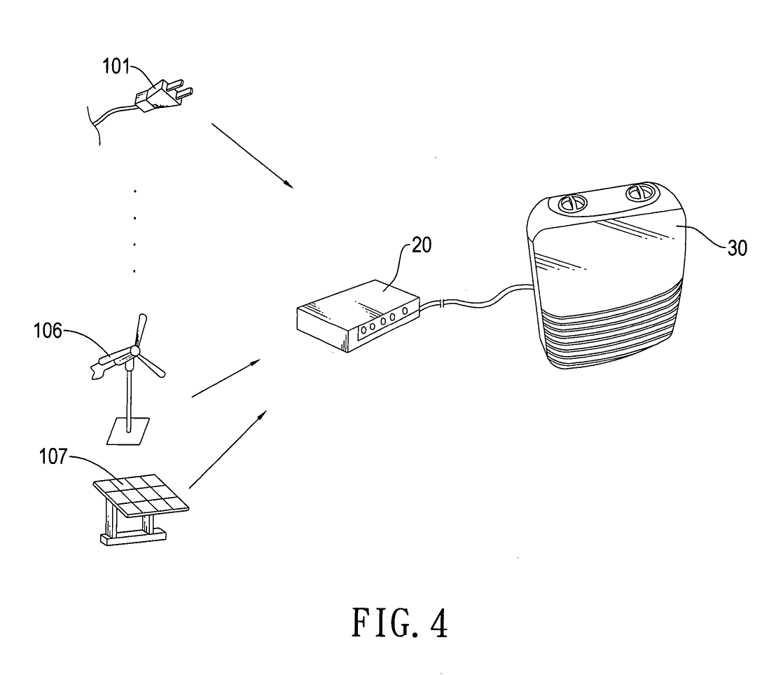

An uninterruptible power supply device 20 comprises a built-in power source selector 201 and a constant-current controller 202. The uninterruptible power supply device 20 is connected to the at least two power sources 10 via the power source selector 201. The power source selector 201 can effect selection among the power sources 10 by means of software, or the selection can be realized directly through hardware, such as relays, reed switches, motors and the likes. Referring to FIG. 4, the power source selector 201 in the embodiment illustrated effects selection among the power sources 10 by means of hardware and the power source selector 201 is comprised of a power factor correction/PV (photovoltaic) inverter 2011, two MPPT (Maximum Power Point Tracking) chargers 2012, 2013, and a DC/DC converter 2014. The two MPPT chargers 2012, 2013 are connected to the DC/DC converter 2014, which is connected in parallel to the power factor correction/PV inverter 2011. The constant-current controller 202 of the uninterruptible power supply device 20 is connected to the power source selector 201 and the constant-current controller 202 functions to make power inputs from the at least two power sources 10 distributed for constant current so as to stably control the input.

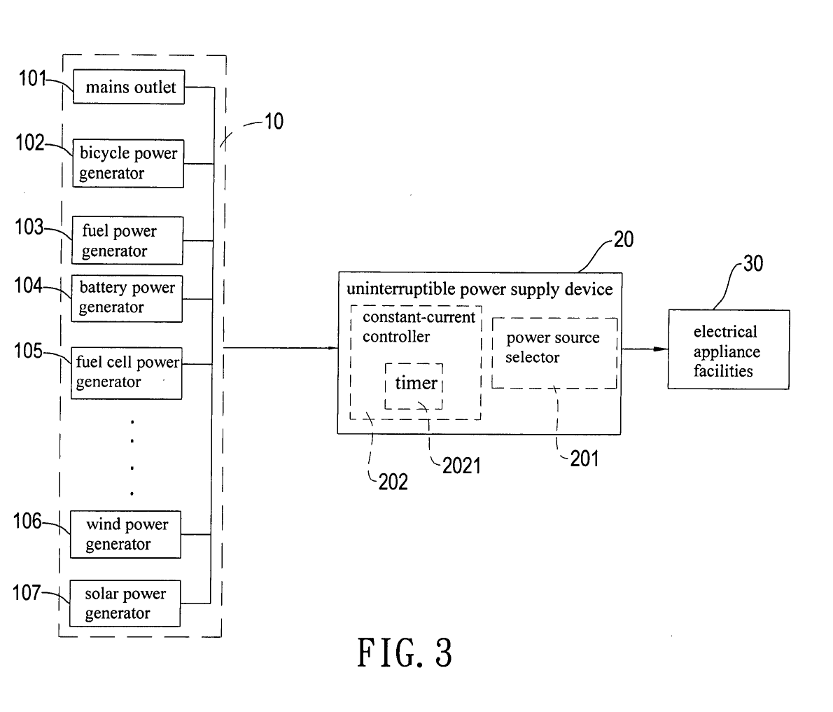

Referring to FIG. 3, the constant-current controller 202 built in the uninterruptible power supply device 20 further comprises a timer 2021, which allows the constant-current controller 202 to not only effect distribution of the input electrical power flow from each power source 10, but also control the time point of input for each power source 10 via the timer 2021.

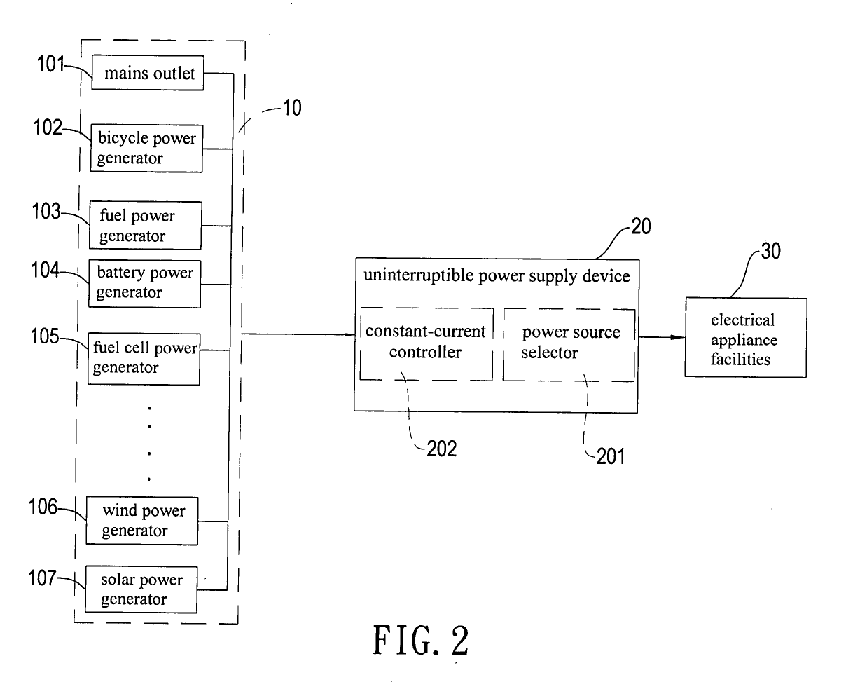

Referring to FIGS. 2-4, the uninterruptible power supply device 20 has output terminals that receive the insertion and connection of various electrical appliance facilities 30, such as computer equipment and air conditioners. When the weather is clear in the daytime, the solar power generator 107 provides a high level power input, while the power input from the wind power generator 106 is relatively unstable due to the random wind speed. The power source selector 201 and the constant-current controller 202 built in the uninterruptible power supply device 20 automatically detect the current power inputs from each power source 10 to allow the power source selector 201 to make judgment and selection. Further, the constant-current controller 202 can schedule the input power flow and carry out input time control. For example, the solar power generator 107 is started to supply electrical power from 8 o'clock AM in the morning to 5 o'clock PM in the evening. After the sun sets or when weather changes to raining with relatively weak sun light, the constant-current controller 202 cuts off the power input from the solar power generator 107 and switches to power inputs from other power generators. Further, constant-current controller 202 also functions to control the input power flow from each power source 10. For example, the wind power generator 106 is susceptible to the instability of surrounding wind power and wind speed to thereby have the input power flow from the wind power generator 106 undesirably affected and the constant-current controller 202 can function to have it generating stable power input. Further, at the same time when supplying electrical power for being used by the electrical appliance facilities 30, the uninterruptible power supply device 20 can store up an excessive fraction of the power generated by each power generator, and when any one of the power generators fails to properly generate power, the uninterruptible power supply device 20 can release the stored electrical power to maintain proper operation of the electrical appliance facilities 30 without being adversely affected.

Referring to FIGS. 1-5, the inverter in accordance with the present invention features a combination of at least two power sources 10 and an uninterruptible power supply device 20 wherein the uninterruptible power supply device 20 comprises a power source selector 201 and a constant-current controller 202 built therein and the uninterruptible power supply device 20 is connected to the at least two power sources 10 via the power source selector 201 and wherein the power source selector 201 and the constant-current controller 202 function to effect distribution and adjustment of power inputs from various power sources 10. It is concluded that the present invention is effective in time-scheduling and constant-current based distribution of the power inputs from various power sources 10 to thereby provide stable power input for the use by electrical appliance facilities 30.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An inverter comprising:
at least two power sources of which one power source comprises a mains outlet; and
an uninterruptible power supply device comprising a power source selector and a constant-current controller built therein, the uninterruptible power supply device having output terminals adapted to connect external electrical appliance facilities and input terminals connected to the at least two power sources via the power source selector and the constant-current controller;
wherein the power source selector and the constant-current controller function to effect distribution and adjustment of the at least two power sources for use by the electrical appliance facilities.

2. The inverter as claimed in claim 1, wherein the at least two power sources comprise direct-current (DC) power sources and alternate-current (AC) power sources.

3. The inverter as claimed in claim 1, wherein the at least two power sources comprises a power source selected among fuel power generator, solar power generator, wind power generator, man power generator, and fuel power generator.

4. The inverter as claimed in claim 1, wherein the power source selector built in the uninterruptible power supply device is realized by means of software.

5. The inverter as claimed in claim 1, wherein the power source selector comprises a power factor correction/PV (photovoltaic) inverter, at least one MPPT (Maximum Power Point Tracking) chargers, and a DC/DC converter, the MPPT charger being connected to the DC/DC converter, which is connected in parallel to the power factor correction/PV inverter.

6. The inverter as claimed in claim 1, wherein the power source selector built in the uninterruptible power supply device is realized by means of hardware, which selectively comprises one of a relay, a reed switch and a motor.

7. The inverter as claimed in claim 1, wherein the constant-current controller built in the uninterruptible power supply device functions to make power inputs from the at least two power sources distributed for constant current so as to provide stable input of power.

8. The inverter as claimed in claim 1, wherein the uninterruptible power supply device comprises a timer for effecting timed control of power inputs from the at least two power sources.
